(19) United States
(12) Patent Application Publication
(10) Pub. No.: US 2005/0116048 A1
(43) Pub. Date: Jun. 2, 2005

(54) Valuable document or security document comprising a switch

(76) Inventors: Dieter Sauter, Reutlingen (DE); Anett Bailleu, Berlin (DE); Konstantin Poetschke, Berlin (DE); Oliver Muth, Berlin (DE); Daniel Grammlich, Pliezhausen (DE); Manfred Paeschke, Basdorf (DE); Armin Franz-Burgholz, Falkensee (DE); Benedikt Ahlers, Berlin (DE)

Correspondence Address: ARENT FOX KINTNER PLOTKIN & KAHN, 1050 CONNECTICUT AVENUE, N.W., SUITE 400, WASHINGTON, DC, 20036, US

(21) Appl. No.: 10/500,918

(22) PCT Filed: Dec. 18, 2002
(86) PCT No.: PCT/EP02/14441

(30) Foreign Application Priority Data
Jan. 10, 2002 (DE) 202 00 358.2
Mar. 30, 2002 (DE) 102 14 370.6

(51) Int. Cl. G06K 19/06

(52) U.S. Cl. 235/492

(57) ABSTRACT

The invention is directed to a value or security document which includes a circuit 2, 3, 4, 5, 6 which is provided with a break adapted to be closed by a conducting element 8 and/or by forming the document along a folding line 7.

This invention relates to a value or security document and to a method of manufacturing a value or security document.

It is known from the prior art to provide value or security documents, such as bank notes, identity cards, driver's licenses, postage stamps, entry tickets, value stamps, credit cards, check cards, stocks, packaging materials and the like with security features which make counterfeit or unauthorized alteration of such documents difficult, if not altogether impossible. The term “document” is furthermore in this sense also understood to mean a product which is provided with a corresponding security feature.

Watermarks are one such known security feature. Such watermarks are visible in backlight and then exhibit a particular motif or numeral, such as the denomination numeral of the relevant bank note.

A further security feature is the security thread. In this case the security check involves holding the document up to a light source to see a darker line in backlight.

It is also known to apply special foil strips with security features, such as holograms. The holograms allow, for example, different symbols or numerals to appear when a bank note is tilted, depending on the angle of observation.

The use of nacreous strips is also known for the production of security features. When the bank note is tilted a, for example, gold-colored strip becomes visible in which a symbol and the respective denomination numeral can be discerned. There is a nacreous strip of this type for example on the 20 Euro bill.

From U.S. Pat. No. 5,403,039 a printed document as, for example, a lottery ticket, is known, which includes a thermochromic layer. The thermochromic layer is applied over data printed on the document. For authentication, heat is applied to the thermochromic layer such as by contacting it with a finger. When the document is genuine, a reversible color change will take place.

From U.S. Pat. No. 5,826,915 a security document having a thermochromic material printed thereon is known. The thermochromic material is heated by a rubbing action, whereupon a corresponding security feature appears.

The above-named security features, which are known from the prior art, are “public features”, i.e., security features which can be checked by anyone without the aid of special devices and without particular knowledge being required.

It is an object of the present invention to provide an improved value or security document and an improved method of manufacturing a value or security document.

The object underlying the present invention is respectively achieved by the features of the independent patent claims. Preferred embodiments of the invention are given in the dependent patent claims.

With the invention it is possible to produce a value or security document with a switch. The switch is preferably realized such that at least one of the conducting tracks of an electric or electronic circuit applied to the value or security document is interrupted. By closing this break, the security feature provided by the circuit is activatable.

In a preferred embodiment of the invention the break is closed by a conducting element situated on the value or security document itself. For this purpose, the value or security document has a formable substrate. The conducting element is arranged on the value or security document in such a way that by suitably forming the document, that is, as by kinking, folding or bending, the conducting element can be placed over the break to close the break electrically. This closes a circuit mounted on the value or security document, thereby activating a security feature.

In another preferred embodiment of the present invention the break is closed by means of an external conducting element. Preferably, the size of the break is selected so that the break can be closed with a coin.

In another preferred embodiment of the invention a source of supply is mounted on the value or security document. This may be a battery, a solar cell or an antenna, for example. The source of supply serves to supply power to a transducer constituting the safety feature of the value or security document. The transducer may be designed to issue a visual, audible and/or electromagnetic signal.

In another preferred embodiment of the invention the value or security document has a substrate layer made of paper or plastics. This is particularly advantageous for ease of formability of the document in order to close the break by means of a conducting element held on the document.

In another preferred embodiment of the invention one, several or all the elements of the circuit, in particular the conducting element for closing the break, are printed on the value or security document by means of a printing technique. Printing techniques especially suited for this purpose include ink jet printing, screen printing, letterpress printing, intaglio printing and planographic printing. Suitable electrically conducting printing inks are per se known from the prior art (cf. Hans Hofstraat “Will Polymer Electronics Change the Electronics Industry?”, Polytronic 2001, Conference Proceedings).

The production of solar cells on thin films is also known per se from the art (cf. “Plastic Solar Cells”, Adv. Funct. Mater. 2001, 11, No. 1, February, pages 15 to 26).

In this context, it is of particular advantage that an active or passive source of supply on the value or security document is capable of realizing a system that forms an integral part of the value or security document. This is the case particularly when the corresponding circuit is applied, at least in part, on a substrate of the value or security document using a printing technique. This also enables comfortable handling of the value or security document, particularly when applied to bank notes and other documents that are usually kinked, bent or folded.

Furthermore, particular securing against counterfeiting is thereby provided because a circuit applied to the value or security document by a printing technique is extremely hard to duplicate or alter, if not altogether impossible.

According to another preferred embodiment of the invention at least two circuit patterns, which are separated from one another by a break, are printed on the value or security document. By forming the document, the two circuit patterns can be superimposed in such manner that contact is made and a functional electrical or electronic component is provided.

In this manner, a coil, for example, can be realized on the value or security document. To accomplish this, two coil winding halves are printed on the document separate from each other. The coil winding halves are separated from each other by a line suitable for kinking, bending or folding. This enables the document to be formable in such manner that the two coil winding halves can be superimposed, thus producing a coil while at the same time activating the relevant security feature. In the case of a coil this security feature is, for example, a magnetic field produced by the coil which can be checked as by means of a Hall probe.

Alternatively, a coil is realized by printing individual conducting tracks on the document in a diagonally offset relation to each other. When the document is folded, each of the conducting tracks then makes contact with the end of a diagonally opposite conducting track. In this manner, each of the conducting tracks becomes one turn of the coil thus produced.

Preferred embodiments of the present invention will be described in more detail in the following with reference to the accompanying drawing. In the drawing,

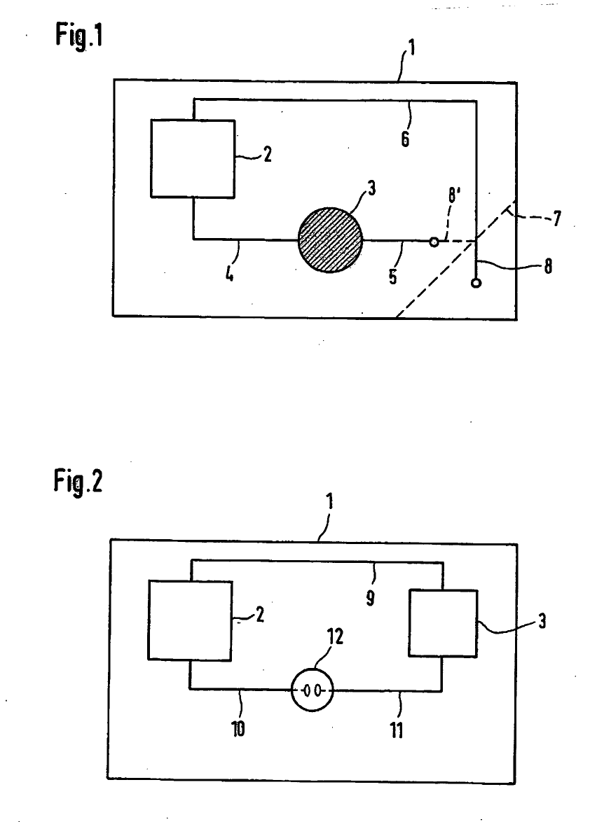

FIG. 1 is a block diagram illustrating a first embodiment of a value or security document of the invention with a folding line for closing a circuit arranged on the document;

FIG. 2 is a view of a second embodiment of a value or security document of the invention with a circuit provided with a break adapted to be closed by a coin;

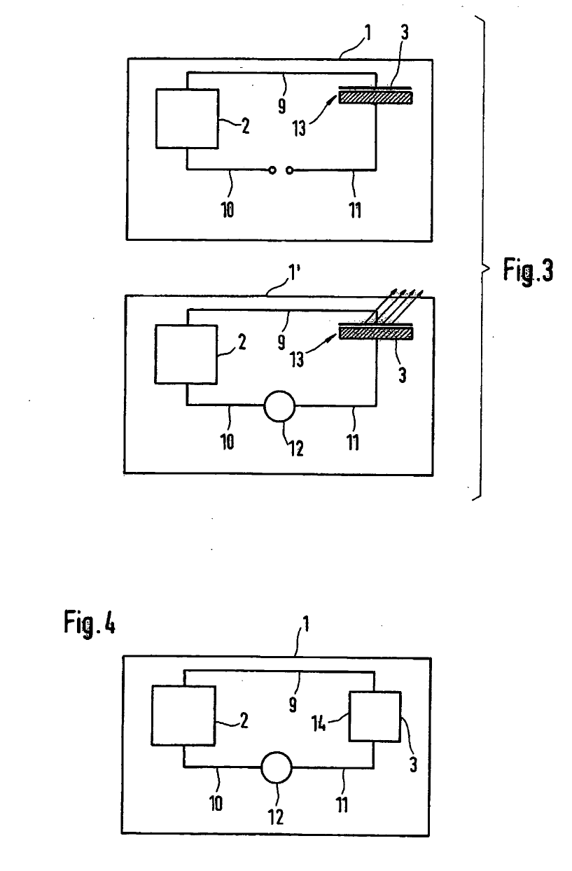

FIG. 3 is a view of another embodiment of a document of the invention with an electroluminescent security feature;

FIG. 4 is a view of still another embodiment of a value or security document of the invention with an electrochromic security feature; and

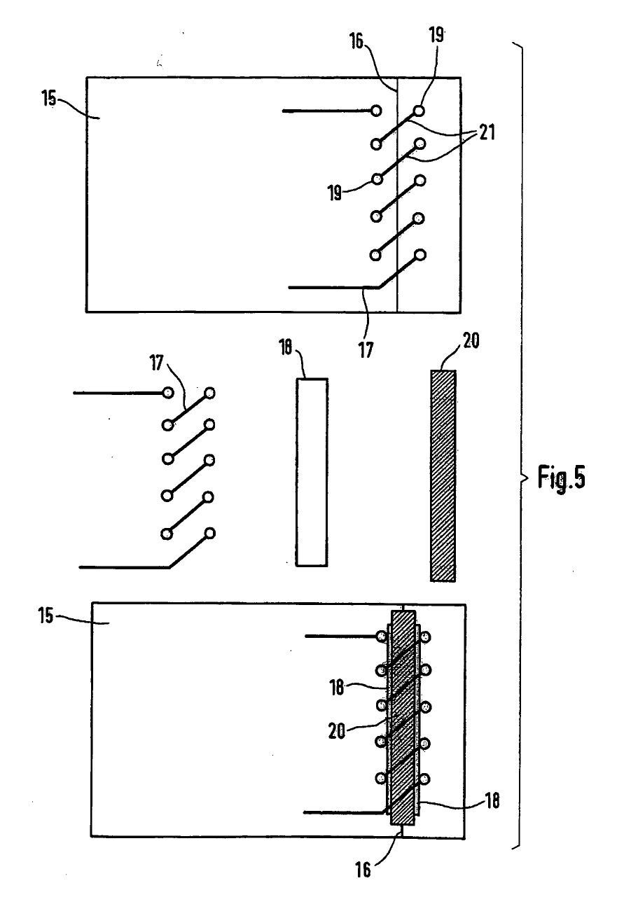

FIG. 5 is a depiction of the manufacture and mode of operation of a coil realizable on a value or security document by a switching operation.

FIG. 1 shows a value or security document 1 with a source of supply 2 and a transducer 3.

The source of supply 2 is connected to a port of the transducer 3 via a conducting element 4. The transducer 3 has its other port connected to a conducting element 5. The source of supply 2 is also connected to a conducting element 6.

The document 1 has a substrate made of paper and/or a plastics film. This substrate has a folding line 7 extending below the conducting element 6. An end region 8 of the conducting element 6 is thereby defined.

The source of supply 2 may be an active or a passive source of supply, that is, a battery, solar cell or antenna, for example. The source of supply 2 serves to supply electrical energy to the transducer 3. The transducer 3 operates to transform the electrical energy to another form of energy as, for example, light, an acoustic wave, an electromagnetic wave or an electric or magnetic field.

The transducer 3 may be a light-emitting diode, preferably an organic light-emitting diode. The manufacture of printable, organic light-emitting diodes, called OLEDs, is known per se from “OLED Matrix Displays: Technology and Fundamentals”, Polytronic 2001, Conference Proceedings, Oct. 21-24, 2001.

The transducer 3 may also be a device referred to as a folding loudspeaker. The manufacture of a folding loudspeaker is also known per se from the prior art (http://www.heise.de, notice dated Apr. 27, 2001 “Faltlautsprecher für die Hosentasche”).

The transducer 3 may furthermore include a coil for producing a magnetic field that is detectable by means of a Hall probe. In principle, any physical and/or chemical processes may be used for transforming the electrical energy supplied by the source of supply 2 to another form of energy detectable from outside.

With the transducer 3 a security feature is thus realized on the document 1, for example, by a flashing LED, by providing an audible signal or by generating a magnetic field.

In initial condition the electric circuit of the document 1, which is comprised of the source of supply 2, the transducer 3 and the conducting elements 4, 5 and 6 is open, so that the transducer receives no electric power, being hence deactivated. To check the security feature it is thus necessary for this circuit to be closed.

This is accomplished according to the invention by folding the document 1 along the folding line 7 so that the end region 8 occupies the position identified by 8′, making contact with the conducting element 5. In this manner the circuit is closed and the transducer 3 is activated. It is then possible to check the security feature.

Preferably, at least the conducting elements 4, 5 and 6 are printed on the document 1 by means of conducting printing ink. The source of supply 2 and/or the transducer 3 may be produced, for example, on a thin film that is applied to the document 1. Alternatively, it is also possible for the source of supply 2 and/or the transducer 3 to be realized by means of various printing inks using one or several printing passes.

To establish contact between the respective ends of the two conducting elements 5 and 8, the ends of the conducting elements 5 and 8, which are to establish contact, are routed to the surface of the document 1, being thus exposed. In a preferred embodiment at least partial regions of the remaining circuit elements (the transducer 3, the conducting elements 4 and 6, the source of supply 2 and those regions of the conducting elements 5 and 8 that do not comprise the contact-making ends) are covered by a protective coat not shown. This protective coat is transparent in one region of the transducer 3, so that an emission of electromagnetic radiation, for example, is visible or detectable through the protective coat. In another embodiment the protective coat is transparent in the region of the source of supply 2, particularly in cases when the source of supply is a solar cell. The protective coat preferably consists of plastics material. In those regions where the contact-making ends of the conducting elements 5 and 8 are disposed, the protective coat has apertures to enable these ends to be exposed. In a further embodiment the protective coat may also be a printed layer. Advantageously, the protective coat is constructed as an insulating layer. In still another embodiment the protective coat may also be composed of several layers. In a preferred embodiment the protective coat is printed or laminated-on subsequent to applying the circuit.

FIG. 2 shows an alternative embodiment of the document 1. In this embodiment the source of supply 2 and the transducer 3 are interconnected by means of a conducting element 9. The source of supply 2 is further connected to a conducting element 10, and the transducer 3 to a conducting element 11. The conducting elements 10 and 11, rather than making contact, are spaced from each other, so that the circuit of the document 1, comprised of source of supply 2, transducer 3 and the conducting elements 9, 10 and 11, shows a break. Hence the transducer 3 receives no electrical energy and is therefore deactivated.

To check the security feature the break between the conducting elements 10 and 11 is closed as by means of a coin 12. To accomplish this, the distance between the conducting elements 10 and 11 is dimensioned to enable a user to place the coin 12 over the break without difficulty to complete the electric circuit. For greater clarity of illustration, the ends of the conducting elements 10 and 11 lying underneath the coin 12 are drawn in broken lines.

Similar to the embodiment explained with reference to FIG. 1, in a preferred embodiment provision is made for a protective coat, not shown, which, with the exception of the contact-making ends of the conducting elements 10 and 11, covers the elements of the circuit at least partially, providing protection against environmental influences. These ends of the conducting elements 10 and 11 are thus exposed. In the regions of the contact-making ends of the conducting elements 10 and 11 the protective coat is accordingly provided with apertures. Similar to the protective coat referred to in the foregoing, this protective coat may be constructed as a plastics layer or printed layer, preferably of the insulating type. In a further embodiment the protective coat may also be partially transparent. Another advantage of the protective coat is that it prevents accidental contact between circuit elements that are not intended for contact making, so that short circuits are avoided.

FIG. 3 shows another embodiment of the document 1 with an electroluminescent security feature. To realize this security feature an electroluminescent layer 13 is provided in the transducer 3. The electroluminescent layer may be applied as by printing using a printing ink with electroluminescent pigments.

The arrangement of the conducting elements 9, 10 and 11 on the document 1 is equivalent to the arrangement of FIG. 2.

With the document 1 in the condition identified by 1′, the break between the conducting elements 10 and 11 is again closed by a coin, so that the circuit is completed. Across the electroluminescent layer 13 a voltage is then present which generates an electric field exciting the electroluminescent pigments in the layer 13 into emitting light. By closing the break between the conducting elements 10 and 11 using a coin or the like, it is thus possible to check the document 1 for authenticity.

FIG. 4 shows another embodiment of the document 1. In this embodiment the transducer 3 has a layer 14 that includes an electrochromic dye. This means that the layer 14 undergoes a color change as soon as electric current flows. The layer 14 may be applied by printing using a printing ink with electrochromic properties.

When the break between the conducting elements 10 and 11 is closed by a coin 12, an electric current is allowed to flow causing the color of the layer 14 to change. From this color change it can be concluded that the document 1 is genuine.

FIG. 5 shows a value or security document 15 on which a coil is realized. The further elements of the circuit of the document 15 are not shown in FIG. 5 for the sake of clarity of illustration. The coil is capable of fulfilling various functions in the circuit of the document 15. For example, the coil may be part of a resonant circuit or serve to produce a magnetic field.

The document 15 has a folding line 16 or a folding zone 16 along which the document 15 is preferably weakened to allow easy folding, bending, rolling or kinking. The folding line 16 defines at the same time the longitudinal axis of the coil.

The coil comprises an “unwound” winding 17 which is printed on the document 15 over the folding line 16 by means of an electrically conducting printing ink. The coil winding 17 is comprised of individual conducting tracks 21 separated from one another electrically and arranged in parallel diagonally along the folding line 16, so that end regions 19 of the conducting tracks lie opposite each other in pairs with respect to the folding line 16.

An electrically insulating layer 18 is then printed over the coil winding 17 by means of an electrically insulating printing ink. This layer 18 covers the coil winding 17 along the folding line 16, leaving however the end regions 19 of the conductors of the coil winding half 17 free.

Preferably, a layer 20 of printing ink with magnetic particles is furthermore printed on the layer 18. The magnetic particles are preferably particles of high permeability. The layer 18 serves for electric insulation of the layer 20 from the conducting tracks of the coil winding half 17 lying underneath.

In the condition illustrated in FIG. 5 the coil is not operative because the individual conducting tracks of the coil winding 17 are not in contact with each other. However, when the document 15 is folded or bent along the folding line 16, opposite lying conducting tracks of the coil winding half 17 make contact in pairs, thus producing a coil-shaped closed line enveloping the layer 20. This closes the circuit of the document 15 while at the same time the coil is realized. With the current flowing, the coil produces a magnetic field that may be used for checking the authenticity of the document 15.

Alternatively, the possibility also exists to print two coil winding halves on the document 15, with the coil winding halves being separated from one another by a folding line; by folding the document along the folding line the two coil winding halves are then superimposed, resulting in a coil.

In the embodiments of the invention described with reference to FIG. 3, FIG. 4 or FIG. 5 provision may be made again for one or several similar protective coats.

By referring to the embodiments indicated in the foregoing it is possible to obtain a value or security document that includes a public feature security element.

Corresponding approaches may be used to realize any other electrical or electronic components, which include printing conducting patterns on the document which do not make contact with each other unless the document is formed in a predetermined fashion, resulting in a functional component.

### List of Reference Characters

Document 1
Source of supply 2
Transducer 3
Conducting element 4
Conducting element 5
Conducting element 6
Folding Line 7
End Region 8
Conducting Element 9
Conducting Element 10
Conducting Element 11
Coin 12
Electroluminescent Layer 13
Layer 14
Document 15
Folding Line 16
Coil Winding Half 17
Layer 18
End Region 19
Layer 20
Conducting Tracks 21

1. A value or security document,
characterized in that said value or security document includes a circuit (2, 3, 4, 5, 6; 9, 10, 11; 21) and said circuit is provided with a break adapted to be closed by a conducting element (8; 12; 21).

2. The value or security document according to claim 1 wherein said conducting element (8; 21) is situated on the document and said conducting element is movable across the break by forming the document.

3. The value or security document according to claim 2 wherein said document forming operation involves a kinking, bending, rolling and/or folding process.

4. The value or security document according to claim 3 wherein said value or security document has a predetermined kinking, bending and/or folding line or a kinking, bending and/or folding zone (7, 16) along which the forming operation essentially takes place.

5. The value or security document according to claim 4 wherein said predetermined kinking, bending and/or folding line or kinking, bending and/or folding zone is constructed in such manner that the forming operation is essentially reversible.

6. The value or security document according to any one of the preceding claims 1 to 5 wherein said break is constructed to be closable by an external conducting element (12).

7. The value or security document according to claim 6 wherein the external conducting element is a coin (12).

8. The value or security document according to claim 1 wherein a security feature is activatable by closing the break with the conducting element.

9. The value or security document according to claim 8 wherein said security feature is realized by a component designed to issue a visual and/or audible and/or electromagnetic signal.

10. The value or security document according to any one of the preceding claims 1 to 5, 8 or 9 wherein provision is made for a protective coat on at least one section of the circuit, said protective coat having an aperture in the region of the break so that the break is exposed.

11. The value or security document according to claim 1 with a source of supply wherein said source of supply is a battery and/or a solar cell and/or an antenna.

12. The value or security document according to claim 11 wherein said break is designed in such manner that the security feature is activated by closing the break with the conducting element.

13. The value or security document according to claim 1 with a first circuit pattern (19) and with a second circuit pattern (19) which are separated from one another by the break and superimposable one upon the other by forming of the document so that the break is closed.

14. The value or security document according to claim 13 wherein said first circuit pattern and said second circuit pattern result in a coil subsequent to the document forming operation.

15. The value or security document according to claim 1 with a substrate made of paper and/or plastics film.

16. The value or security document according to claim 15 wherein one or several elements of the circuit, in particular the conducting element, are printed onto the document by means of a printing ink.

17. A method of manufacturing a value or security document, said method comprising the steps of
providing a substrate;
printing a circuit onto said substrate, said circuit having a break and said break being closable by a conducting element.

18. The method according to claim 17, which comprises applying a protective coat to at least one section of the circuit, said coat having apertures in the region of the break causing the break to be exposed.

19. The method according to any one of the preceding claims 17 or 18, which for printing the circuit comprises printing a first circuit pattern and a second circuit pattern which are separated from one another by the break so that by forming of the document the first circuit pattern and the second circuit pattern are superimposable one upon the other.

20. The method according to claim 19 wherein said first circuit pattern is a first coil winding half and said second circuit pattern is a second coil winding half, with a layer of insulating printing ink being printed over a region of the coil winding halves.

21. The method according to claim 20, which comprises printing on said region a layer of a printing ink with a magnetic property, preferably a printing ink with particles of high permeability.
